(19) United States
(12) Patent Application Publication
(10) Pub. No.: US 2024/0126979 A1
(43) Pub. Date: Apr. 18, 2024

(54) INFORMATION ACQUISITION APPARATUS, INFORMATION ACQUISITION METHOD, AND INFORMATION ACQUISITION PROGRAM

(71) Applicant: Nippon Telegraph and Telephone Corporation, Tokyo (JP)

(72) Inventors: Hidetaka KOYA, Musashino-shi, Tokyo (JP); Akira KATAOKA, Musashino-shi, Tokyo (JP)

(21) Appl. No.: 18/277,453

(22) PCT Filed: Feb. 24, 2021
(86) PCT No.: PCT/JP2021/006951

§ 371 Date: Aug. 16, 2023

(51) Int. Cl. G06F 40/14; G06F 40/274

(52) U.S. Cl. CPC G06F 40/14; G06F 40/274

(57) ABSTRACT

An information acquisition apparatus (100) includes an acquisition unit (121), a classification unit (122), a determination unit (123), and a registration unit (124). The acquisition unit (121) acquires tree information representing information of a system screen by a plurality of nodes having a tree structure. The classification unit (122) classifies the plurality of nodes having a tree structure into an operable component and a label component based on the tree information. The determination unit (123) determines whether the label component indicates a name of the operable component based on a distance between the operable component and the label component. The registration unit (124) registers a correspondence between a text corresponding to the label component and specifying information for specifying the operable component in a case where the determination unit (123) determines that the label component indicates a name of the operable component.

### TECHNICAL FIELD

The present disclosure relates to an information acquisition apparatus, an information acquisition method, and an information acquisition program.

### BACKGROUND ART

In recent years, various techniques have been proposed to implement improvement and efficiency of work. For example, as a technique for improving work, a technique of automatically operating a screen of a system by various means has been proposed. In such a technique, a name of a component that is a target of an automatic operation is associated with specifying information for specifying the component. In addition, a correspondence between the name and the specifying information is registered. Such association and registration are manually performed.

On the other hand, regarding a technique for improving work, as a technique related to an Excel (registered trademark) form, a technique of automatically acquiring a correspondence between an item name and an item value in a table has been proposed (Patent Literature 1). In this technique, a correspondence between an item name and an item value in a table is acquired by using a positional relationship between cells in an Excel form.

### CITATION LIST

### Patent Literature

Patent Literature 1: JP 2017-219882 A

### SUMMARY OF INVENTION

### Technical Problem

However, in the technique in the related art, it is difficult to easily acquire a correspondence between a name of a component that is a target of an automatic operation and information for specifying the component from a system screen.

For example, in a case where the technique in the related art is applied to a system screen, in the technique in the related art, a system screen formatted in the format of an Excel form is used to acquire a correspondence between an item name and an item value in a table. However, it is difficult to automatically format a system screen in the format of an Excel form.

The present application has been made in view of the above circumstances, and an object of the present application is to easily acquire a correspondence between a name of a component that is a target of an automatic operation and information for specifying the component.

### Solution to Problem

According to an embodiment of the present disclosure, there is provided an information acquisition apparatus including: an acquisition unit that acquires tree information representing information of a system screen by a plurality of nodes having a tree structure; a classification unit that classifies the plurality of nodes having a tree structure into an operable component and a label component based on the tree information; a determination unit that determines whether the label component indicates a name of the operable component based on a distance between the operable component and the label component; and a registration unit that registers a correspondence between a text corresponding to the label component and specifying information for specifying the operable component in a case where the determination unit determines that the label component indicates a name of the operable component.

### Advantageous Effects of Invention

According to one aspect of the embodiment, it is possible to easily acquire a correspondence between a name of a component that is a target of an automatic operation and information for specifying the component.

### BRIEF DESCRIPTION OF DRAWINGS

FIG. 1A is an explanatory diagram illustrating an example of registration of a correspondence between a name of a target of an automatic operation and information for specifying the target of the automatic operation.

FIG. 1B is an explanatory diagram illustrating an example of registration of a correspondence between a name of a target of an automatic operation and information for specifying the target of the automatic operation.

FIG. 1C is an explanatory diagram illustrating an example of registration of a correspondence between a name of a target of an automatic operation and information for specifying the target of the automatic operation.

FIG. 2 is a diagram illustrating an example of a configuration of an information acquisition system according to an embodiment.

FIG. 3A is an explanatory diagram illustrating an outline of information acquisition processing according to the embodiment.

FIG. 3B is an explanatory diagram illustrating an outline of information acquisition processing according to the embodiment.

FIG. 3C is an explanatory diagram illustrating an outline of information acquisition processing according to the embodiment.

FIG. 3D is an explanatory diagram illustrating an outline of information acquisition processing according to the embodiment.

FIG. 4 is a diagram illustrating an example of a configuration of an information acquisition apparatus according to the embodiment.

FIG. 5 is an explanatory diagram illustrating an example of a distance between an operable component and a label component.

FIG. 6 is a flowchart illustrating an example of processing that is executed by the information acquisition apparatus according to the embodiment and is for automatically acquiring a correspondence between a name of a target of an automatic operation and specifying information for specifying the target of the automatic operation.

FIG. 7 is a flowchart illustrating an example of processing that is executed by the information acquisition apparatus according to the embodiment and is for classifying a plurality of nodes into an operable component, a label component, and other components.

FIG. 8 is a flowchart illustrating another example of processing that is executed by the information acquisition apparatus according to the embodiment and is for classifying a plurality of nodes into an operable component, a label component, and other components.

FIG. 9 is a flowchart illustrating an example of processing that is executed by the information acquisition apparatus according to the embodiment and is for determining a maximum likelihood node as a node which is most likely to indicate a name of an operable component.

FIG. 10 is a flowchart illustrating another example of processing that is executed by the information acquisition apparatus according to the embodiment and is for determining a maximum likelihood node as a node which is most likely to indicate a name of an operable component.

FIG. 11 is a diagram illustrating an example of a hardware configuration.

### DESCRIPTION OF EMBODIMENTS

Hereinafter, embodiments of the present disclosure will be described in detail with reference to the drawings. Note that the present invention is not limited by these embodiments. Details of one or a plurality of embodiments are described in the following description and drawings. In addition, the plurality of embodiments can be appropriately combined as long as it does not cause contradiction in processing content. Further, in the following one or plurality of embodiments, the same portions are denoted by the same reference numerals, and redundant description will be omitted.

### 1. Introduction

There is a technique of implementing improvement and efficiency of work by automatically operating a system screen by various means. In order to perform an automatic operation, information for specifying a target of the automatic operation is acquired. The information for specifying the target of the automatic operation may be described below as “specifying information”. In addition, a name that is easily recognized by a person is given to the target of the automatic operation. A correspondence between the specifying information and the name is managed by a user of a system.

The name is mainly used to create a rule of the automatic operation. The specifying information is not in a format that is easily recognized by a person. For this reason, a user of a system creates a rule of the automatic operation using the name.

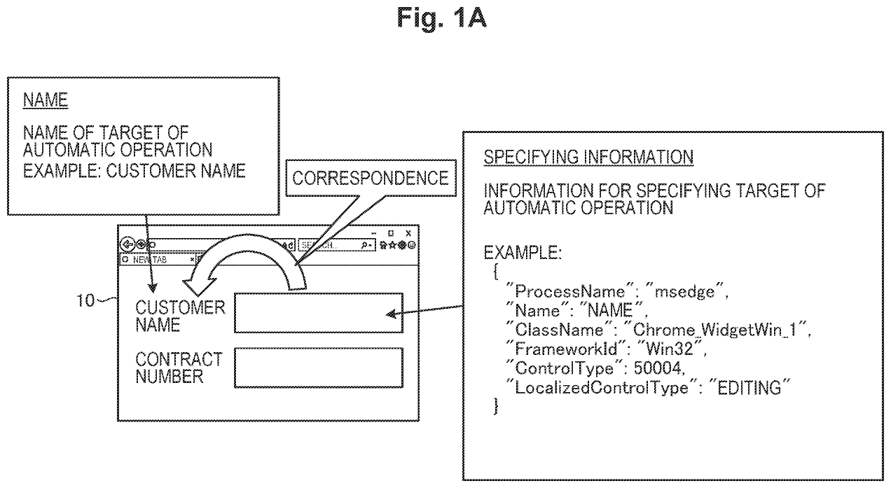

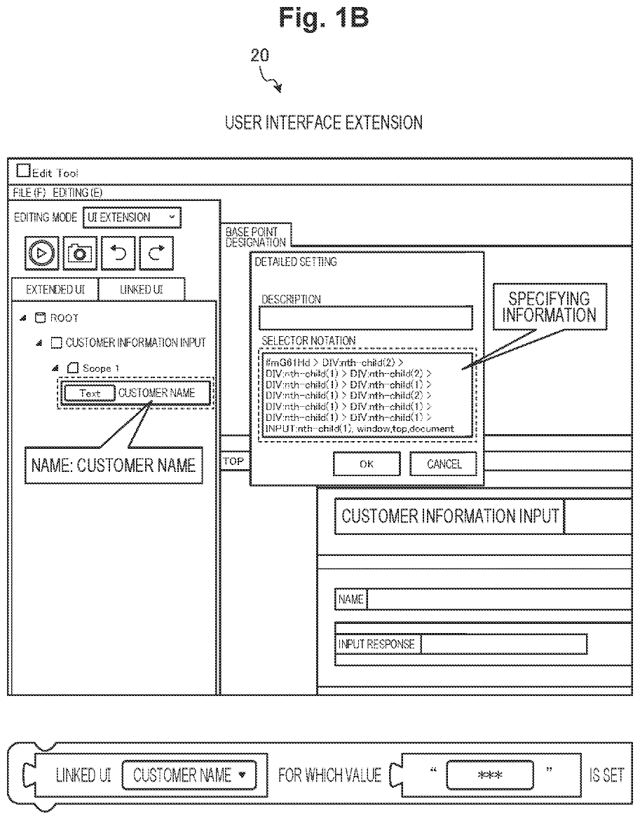

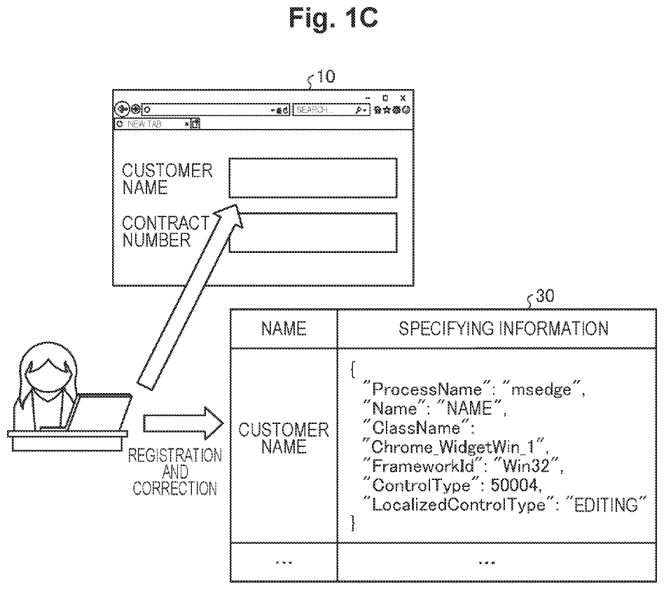

FIG. 1A, FIG. 1B, and FIG. 1C are explanatory diagrams illustrating an example of registration of a correspondence between the name of the target of the automatic operation and the information for specifying the target of the automatic operation.

FIG. 1A illustrates an example of a pair of the name and the specifying information. A system screen 10 includes a label “customer name”. In addition, the system screen 10 includes a text box. A user associates the text box with the label on the left side of the text box, and registers a correspondence between the specifying information for specifying the text box and the label (name) in a system for performing an automatic operation.

FIG. 1B illustrates an example of a system for performing an automatic operation. FIG. 1B illustrates a screen 20 that is a setting screen of a user interface extension system. The user interface extension system is described by “Hidetaka Koya and four others in “Proposal and Evaluation of the Method for End-User Configuration of the User Interface Augmentation”, IEICE Technical Report, vol. 119, no. 52, ICM2019-4, pp. 59-64, May 2019”. The user can input a correspondence between the name “customer name” and the specifying information on the setting screen. On the user interface extension system, the name and the specifying information are respectively denoted as alias and selector information. In a case of FIG. 1B, the text box corresponding to the label “customer name” is a target of an automatic operation by the user interface extension system.

For registration of the correspondence between the name and the specifying information, in the related art, a user defines a name for each piece of the specifying information of the target of the automatic operation while viewing a system screen (for example, a captured image of a system screen). In addition, the user registers the correspondence between the name and the specifying information by certain management means.

FIG. 1C illustrates a situation where the user manually registers the correspondence between the name and the specifying information. In the example of FIG. 1C, the user views the system screen 10 and registers the correspondence 30 between the name and the specifying information. On the other hand, in a case where the system screen is changed, the user needs to manually correct the correspondence 30 between the name and the specifying information.

In particular, in a case where the number of targets of automatic operations is large, manual registration of the correspondence between the name and the specifying information requires enormous operations. In addition, in a case where the system screen is changed, correction of the correspondence requires enormous operations.

Therefore, an information acquisition apparatus according to the embodiment performs information acquisition processing to be described below in order to mechanically acquire the name corresponding to the specifying information from information of the system screen.

### 2. Configuration of Information Acquisition System

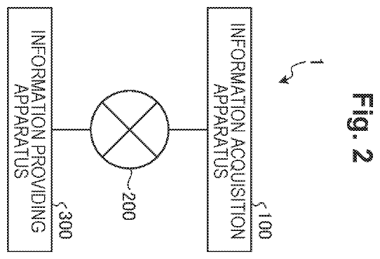

First, an information acquisition system according to the embodiment will be described with reference to FIG. 2.

FIG. 2 is a diagram illustrating an example of a configuration of an information acquisition system 1 according to the embodiment. As illustrated in FIG. 2, the information acquisition system 1 includes an information acquisition apparatus 100 and an information providing apparatus 300. Although not illustrated in FIG. 2, the information acquisition system 1 may include a plurality of information acquisition apparatuses 100 and a plurality of information providing apparatuses 300.

In the information acquisition system 1, the information acquisition apparatus 100 and the information providing apparatus 300 are connected to a network 200 in a wired or wireless manner. The network 200 is, for example, a network such as the Internet, a wide area network (WAN), a local area network (LAN), or the like. The components of the information acquisition system 1 can perform communication with each other via the network 200.

The information acquisition apparatus 100 is an information processing apparatus that determines the name corresponding to the specifying information using information of the system screen and acquires the name corresponding to the specifying information. The information acquisition apparatus 100 executes information acquisition processing to be described below in order to automatically perform registration of the correspondence between the specifying information and the name. An outline of the information acquisition processing will be described in the next section. The information acquisition apparatus 100 may be any type of information processing apparatus including a server. An example of a configuration of the information acquisition apparatus 100 will be described in detail in the next section.

The information providing apparatus 300 is an information processing apparatus that provides information of the system screen to the information acquisition apparatus 100. The information providing apparatus 300 may be any type of information processing apparatus including a client apparatus.

### 3. Outline of Information Acquisition Processing

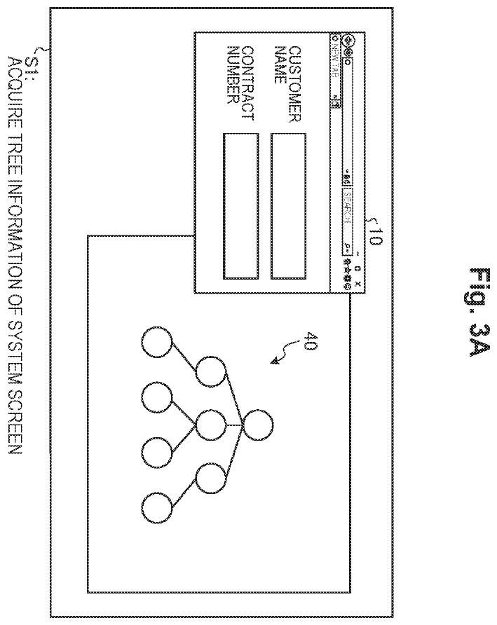

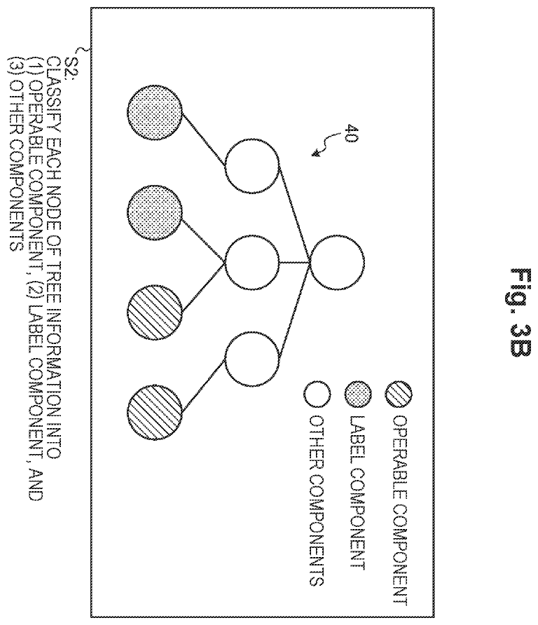

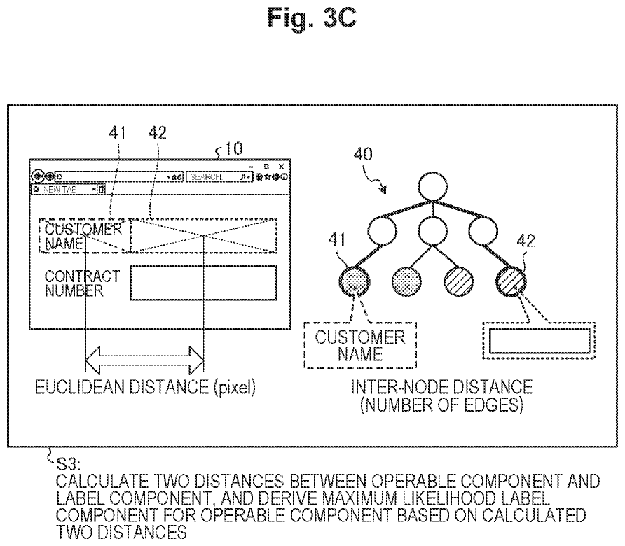

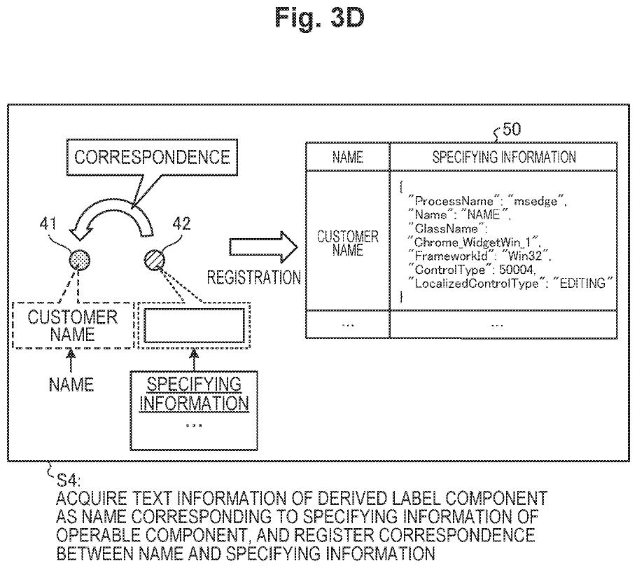

Next, an outline of information acquisition processing will be described with reference to FIG. 3A, FIG. 3B, FIG. 3C, and FIG. 3D. Note that the outline is not intended to limit the present invention and the embodiments to be described in the following section.

FIG. 3A, FIG. 3B, FIG. 3C, and FIG. 3D are diagrams illustrating an outline of information acquisition processing according to the embodiment.

Referring to FIG. 3A, first, the information acquisition apparatus 100 acquires tree information 40 of the system screen 10 (step S1).

Referring to FIG. 3B, next, the information acquisition apparatus 100 classifies each node of the tree information 40 into (1) an operable component, (2) a label component, and (3) other components (step S2). The operable component is a component that can be operated. In the following, a component that can be operated may be referred to as an “operable component”.

Referring to FIG. 3C, next, the information acquisition apparatus 100 calculates two distances between the operable component and the label component, and derives a maximum likelihood label component for the operable component based on the calculated two distances (step S3). In the example of FIG. 3C, the information acquisition apparatus 100 derives a label 41 as a label having a maximum likelihood (a maximum likelihood label component for the operable component) for the name of the text box 42, based on a Euclidean distance (pixel) and an inter-node distance (the number of edges) between the label 41 and the text box 42.

Referring to FIG. 3D, next, the information acquisition apparatus 100 acquires text information of the derived label component as the name corresponding to the specifying information of the operable component, and registers a correspondence between the name and the specifying information (step S4). In the example of FIG. 3D, the information acquisition apparatus 100 associates the label 41 with the text box 42. In addition, the information acquisition apparatus 100 registers the correspondence between the label 41 and the text box 42, as the specifying information 50.

Thereby, the information acquisition apparatus 100 can automate creation of the correspondence between the specifying information and the name of the target of the automatic operation in various solutions for automatically operating the system screen. Therefore, the information acquisition apparatus 100 can greatly reduce operations required to create the correspondence. Similarly, the information acquisition apparatus 100 can also greatly reduce operations required for correcting the correspondence in a case where the system screen is changed.

### 4. Configuration of Information Acquisition Apparatus

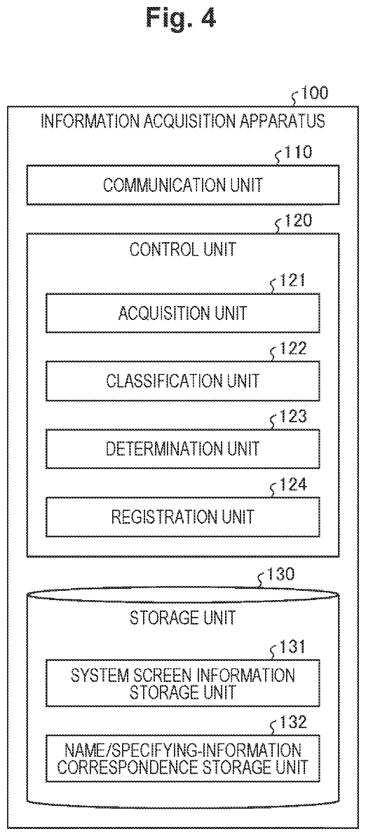

Next, an example of a configuration of the information acquisition apparatus 100 will be described with reference to FIG. 4.

FIG. 4 is a diagram illustrating an example of a configuration of the information acquisition apparatus 100 according to the embodiment. As illustrated in FIG. 4, the information acquisition apparatus 100 includes a communication unit 110, a control unit 120, and a storage unit 130. The information acquisition apparatus 100 may include an input unit (for example, a keyboard, a mouse, or the like) that receives various operations from an administrator or the like who uses the information acquisition apparatus 100, and a display unit (for example, an organic electro luminescence (EL), a liquid crystal display, or the like) for displaying various types of information.

(Communication Unit 110)

The communication unit 110 is implemented by using, for example, a network interface card (NIC) or the like. The communication unit 110 is connected to the network 200 in a wired or wireless manner. The communication unit 110 may be communicably connected to the information providing apparatus 300 via the network 200. The communication unit 110 can transmit and receive information via the network 200.

(Control Unit 120)

The control unit 120 is a controller. The control unit 120 is implemented by, for example, a processor such as a central processing unit (CPU) or a micro processing unit (MPU) that uses a random access memory (RAM) or the like as a work area and executes various programs (corresponding to an example of an information acquisition program) stored in a storage device inside the information acquisition apparatus 100. Alternatively, the control unit 120 may be implemented by, for example, an integrated circuit such as an application specific integrated circuit (ASIC), a field programmable gate array (FPGA), or a general purpose graphic processing unit (GPGPU).

As illustrated in FIG. 4, the control unit 120 includes an acquisition unit 121, a classification unit 122, a determination unit 123, and a registration unit 124, and implements or executes a function or an action of information processing to be described below. One or more processors of the information acquisition apparatus 100 can implement a function of each control unit in the control unit 120 by executing an instruction stored in one or more memories of the information acquisition apparatus 100. Note that the internal configuration of the control unit 120 is not limited to the configuration illustrated in FIG. 4. The internal configuration of the control unit 120 may be another configuration as long as information processing to be described below is performed. For example, the registration unit 124 may perform all or a part of information processing to be described below for the units other than the registration unit 124.

(Acquisition Unit 121)

The acquisition unit 121 acquires information of the system screen. The acquisition unit 121 receives the information of the system screen from the information providing apparatus 300. The acquisition unit 121 stores the information of the system screen in a system screen information storage unit 131. The acquisition unit 121 can acquire the information of the system screen from the system screen information storage unit 131.

The acquisition unit 121 acquires the information of the system screen in a tree format. For example, the acquisition unit 121 acquires tree information of the system screen. The tree information represents information of the system screen by a plurality of nodes having a tree structure.

As an example, the acquisition unit 121 acquires information of the system screen as information in a tree format by using a certain accessibility API. For example, in a case where the application is a Windows (registered trademark) application, the acquisition unit 121 uses user interface (UI) automation or the like. In a case where the application is a Java (registered trademark) application, the acquisition unit 121 uses java access bridge or the like. Such tree information can be confirmed, for example, by the inspect tool provided by Microsoft (registered trademark) or the access bridge explorer provided by Google (registered trademark).

The tree information expresses an inclusion relationship of UI components (for example, a panel, a text box, and the like) of the system in a tree format. Each node of the tree indicates an individual UI component. Each node includes property information of the UI component. The property information includes the specifying information of the operable component and the text information of the label component.

(Classification Unit 122)

The classification unit 122 classifies a plurality of nodes included in the tree information acquired by the acquisition unit 121. The classification unit 122 classifies the plurality of nodes having a tree structure into an operable component and a label component based on the tree information. In addition, the classification unit 122 can also classify the plurality of nodes into other components.

The classification unit 122 classifies the plurality of nodes by using the tree information acquired by the acquisition unit 121. For example, the classification unit 122 acquires property information of the plurality of nodes from the tree information. The classification unit 122 classifies, for example, the plurality of nodes into an operable component, a label component, and other components based on the property information. In this way, the classification unit 122 classifies each node into one of the three components of the operable component, the label component, and the other component based on the property information of each node.

Regarding the node classification using the property information, the classification unit 122 can apply the following two classification methods to the nodes.

A first classification method is a method of mechanically classifying nodes using an operable component control type list and a label component determination condition (for example, a text length, a size). A second classification method is a method using a classifier (clustering). The classification unit 122 creates an operable component list and a label component list by using the first classification method and the second classification method.

First, the first classification method will be described.

The classification unit 122 mechanically classifies the nodes by using the operable component control type list and the label component determination condition.

The classification unit 122 acquires in advance information that enables determination of a type (for example, a panel, a text box, a pull-down, a button, and the like) of a UI component from the property information of the nodes. In the following, the information that enables determination of a type of a UI component may be described as a “control type”. The classification unit 122 prepares in advance a control type list corresponding to the operable components.

In the first classification method, the following four properties are assumed. The following four properties relate to names.

A first assumption is that text information of a label component corresponding to a name has a length of several characters or more. That is, a UI component of which the text information has a length of zero does not correspond to a label component. It is assumed that the length of the text information is a length of several characters or more (generally, three or more characters).

A second assumption is that text information of a label component corresponding to a name is not significantly long.

A third assumption is that a size of a label component corresponding to a name is equal to or larger than a text-readable size. That is, a UI component having a size of zero does not correspond to a label component. It is assumed that a size of a label component is generally equal to or larger than a size of an operable component.

A fourth assumption is that a size of a label component corresponding to a name is not significantly large.

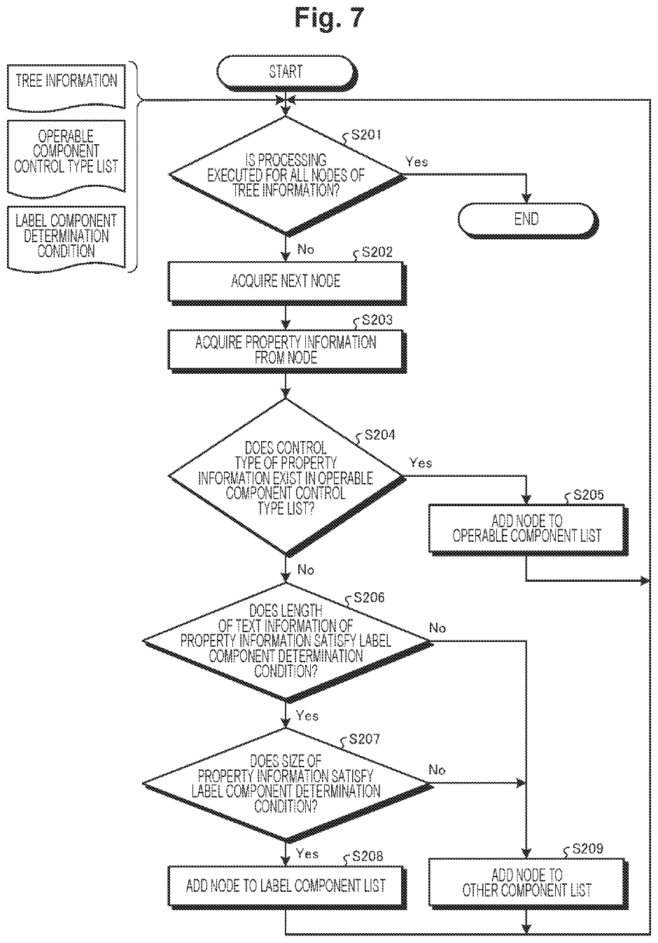

Based on the four assumptions described above, the classification unit 122 prepares in advance “text length (minimum, maximum)” and “size (minimum, maximum)” as label component determination conditions (parameters). The classification unit 122 executes “processing for classifying a plurality of nodes into an operable component, a label component, and other components” to be described below by using, as inputs, “the operable component control type list”, which is a list of control types corresponding to the operable components, and the label component determination condition. The “processing for classifying a plurality of nodes into an operable component, a label component, and other components” will be described in detail below with reference to FIG. 7.

Next, a second classification method will be described.

The classification unit 122 classifies the nodes using a classifier (clustering).

The property information of the nodes includes a combination of property values. The property values correspond to many property names such as various types of ID information and validity/invalidity in addition to the control type and the text information.

First, the classification unit 122 selects a certain number (for example, N) of property names and property values from the property information. In a case where the property value is not a numerical value, the classification unit 122 digitizes the property value by a hash function or the like. Thereby, the classification unit 122 converts the property information into an N-dimensional vector.

Next, the classification unit 122 prepares a data set for learning. The data set is provided as training data for classification (an operable component, a label component, and other components) of the vector of the property information of a certain system screen. The classification unit 122 learns the classifier by using the data set. In the classifier, learning is performed so as to classify a vector corresponding to property information of a UI component into an operable component and a label component.

Thereafter, the classification unit 122 acquires the property information from an unknown node by using the learned classifier. The classification unit 122 vectorizes the acquired property information, and then acquires a classification result by applying the vectorized property information to the classifier. In this way, the classification unit 122 determines the operable component, the label component, and other components.

(Determination Unit 123)

The determination unit 123 determines whether the label component indicates the name of the operable component. Specifically, the label component is a UI component corresponding to a node classified as a label component by the classification unit 122. The operable component is a UI component corresponding to a node classified by the classification unit 122.

The determination unit 123 determines a maximum likelihood node as a node which is most likely to indicate the name of the operable component, from at least one node classified as a label component by the classification unit 122. The maximum likelihood node corresponds to a label component having a maximum likelihood of indicating the name of the operable component. The determination unit 123 determines a maximum likelihood label component by using, as inputs, the tree information acquired by the acquisition unit 121 and the list of the operable component and the label component, the list being created by the classification unit 122.

In order to determine the maximum likelihood node, the determination unit 123 determines whether the label component indicates the name of the operable component based on a distance between the operable component and the label component. As will be described below, examples of the distance between the operable component and the label component include a distance between a position at which the operable component is displayed and a position at which the label component is displayed, and a distance between a node corresponding to the operable component and a node corresponding to the label component. The distance between the positions corresponds to a distance on the display. The distance between the nodes corresponds to the number of edges.

Under an assumption that “the distance on the display between the operable component and the label component corresponding to the operable component is short (in other words, the displayed label component is close to the displayed operable component) and the distance on the tree between the operable component and the label component corresponding to the operable component is also short (in other words, the node corresponding to the label component is close to the node of the operable component)”, the determination unit 123 determines the maximum likelihood label component based on the following two pieces of information.

The first information is a Euclidean distance on the display between the operable component and the label component. The second information is an inter-node distance on the tree between the operable component and the label component.

Regarding the determination of the maximum likelihood label component by using the two pieces of information described above, the determination unit 123 can apply the following two determination methods to the label component.

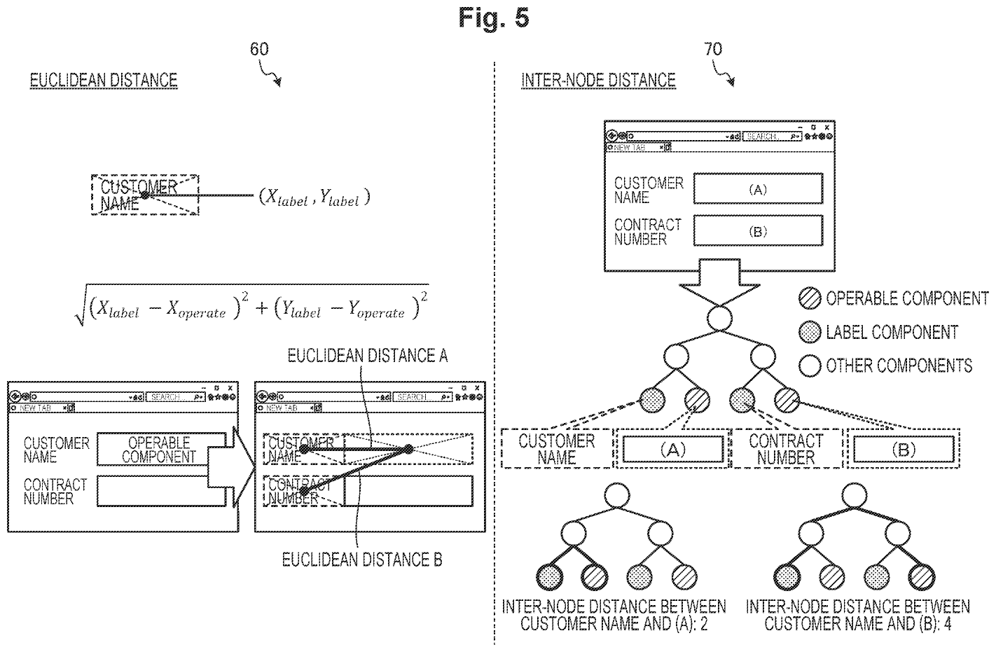

A first determination method is a method of narrowing down label components in order of the inter-node distance and the Euclidean distance. A second determination method is a method of defining a cost function and obtaining a label component having a minimum value of the cost function. The classification unit 122 creates a corresponding component list by using the first determination method and the second determination method. Here, the Euclidean distance and the inter-node distance will be described with reference to FIG. 5.

FIG. 5 is an explanatory diagram illustrating an example of a distance between an operable component and a label component. Examples of the distance between the operable component and the label component include a Euclidean distance and an inter-node distance. FIG. 5 illustrates a calculation process 60 for calculating a Euclidean distance and a calculation process 70 for calculating an inter-node distance.

As illustrated in FIG. 5, the Euclidean distance is defined as a square root of “the square of a difference between an x coordinate of the label component and an x coordinate of the operable component” and “the square of a difference between a y coordinate of the label component and a y coordinate of the operable component”. In the example of FIG. 5, the label component is indicated as “customer name”. In the example, the x coordinate and the y coordinate of the label component are center coordinates of the label component. In addition, the x coordinate and the y coordinate of the operable component are center coordinates of the operable component.

In the example of FIG. 5, the x coordinate and the y coordinate of the label component are indicated as (X_{label}, Y_{label}). (X_{label}, Y_{label}) are an x coordinate and a y coordinate of a center position (circle) of a display region of the label component “customer name”. Similarly, (Xₒₚₑᵣₐₜₑ, Yₒₚₑᵣₐₜₑ) are an x coordinate and a y coordinate of a center position (circle) of a display region of the operable component.

The Euclidean distance A is a distance on the display between the label component “customer name” and the operable component. The Euclidean distance B is a distance on the display between the label component “contract number” and the operable component. The unit of the Euclidean distance is pixel. The Euclidean distance A is shorter than the Euclidean distance B. That is, the label component “customer name” is closer to the operable component than the label component “contract number”.

As illustrated in FIG. 5, the inter-node distance is defined as the number of edges included in a path from a node position of the operable component to a node position of the label component. The inter-node distance is defined in the tree information. In the example of FIG. 5, the inter-node distance between the label component “customer name” and the operable component (A) is 2. The inter-node distance between the label component “customer name” and the operable component (B) is 4. In other words, the inter-node distance is the number of edges through which a search point on the tree passes when the search point on the tree moves from a node position of the operable component to a node position of the label component.

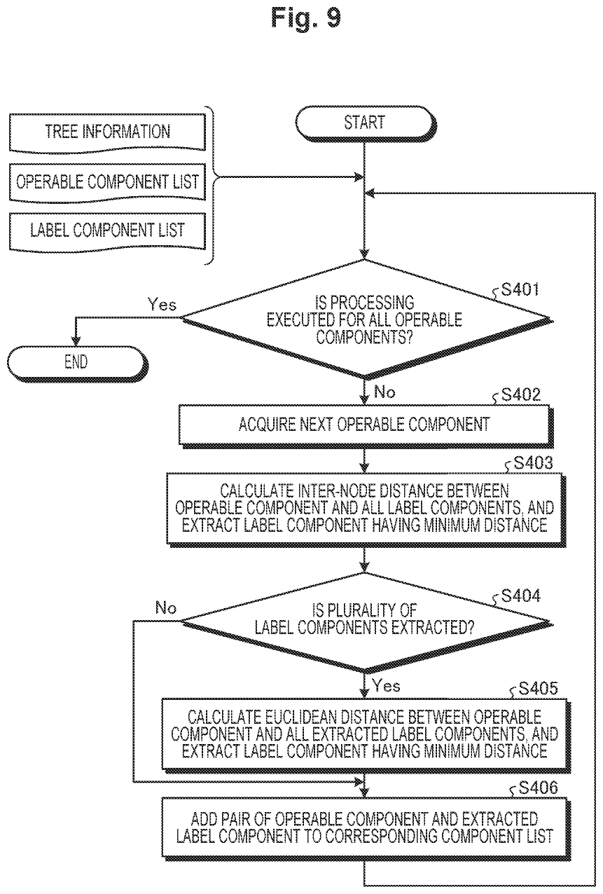

Returning to FIG. 4, in the first determination method, the determination unit 123 narrows down the label components in order of the inter-node distance and the Euclidean distance as described above. In a case where the inter-node distance is used, there is a high possibility that the determination unit 123 extracts a plurality of label components having the same inter-node distance. Here, it is assumed that the number of label components having the same Euclidean distance is small. Under the assumption, the determination unit 123 captures label components in a net by using the inter-node distance. In addition, the determination unit 123 narrows down the label components captured by the net to a single label component by using the Euclidean distance. The processing for narrowing down the label components will be described in detail below with reference to FIG. 9.

In the second determination method, as described above, the determination unit 123 defines a cost function and obtains a label component having a minimum value of the cost function. For example, the cost function is defined as Cost (Dist_{nodes}, Dist_{euclidean})=α·Dist_{nodes}+β·Dist_{euclidean}. The cost function is obtained by respectively multiplying the inter-node distance “Dist_{nodes}” and the Euclidean distance “Dist_{euclidean}” by coefficients α and β, and obtaining a sum of α·Dist_{nodes} and β·Dist_{euclidean}.

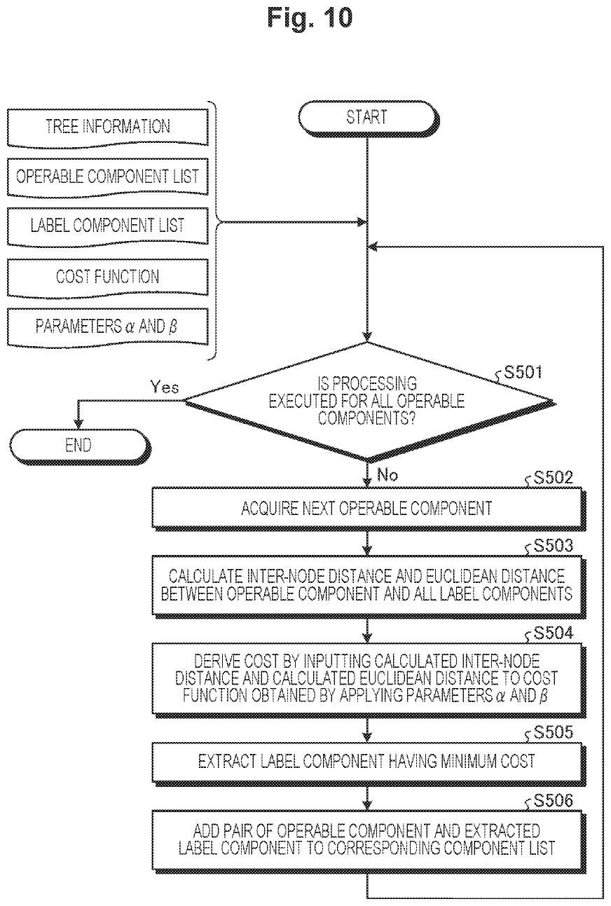

The determination unit 123 extracts a label component having a minimum value of the cost function with respect to the operable component. The determination unit 123 can perform label component determination according to the system screen by parameterizing the coefficients α and β. For example, the determination unit 123 can adjust which distance is emphasized and how much the distance is emphasized. Extraction of a label component using a cost function will be described in detail below with reference to FIG. 10.

(Registration Unit 124)

The registration unit 124 registers a correspondence between a name of an operable component and specifying information for specifying the operable component based on a determination result by the determination unit 123. The name of the operable component is a text corresponding to the label component determined as indicating the name of the operable component by the determination unit 123.

As described above, the specifying information is information for specifying a UI component as a target of an automatic operation. The registration unit 124 acquires the specifying information from the tree information. In addition, the registration unit 124 acquires the text corresponding to the label component from the tree information. The text corresponding to the label component is acquired as a name that is easily recognized by a person. For example, the registration unit 124 acquires property information of a node corresponding to the label component from the tree information. In addition, the registration unit 124 acquires a text corresponding to the label component from the acquired property information.

The registration unit 124 stores the correspondence between the name and the specifying information in a name/specifying-information correspondence storage unit 132. For example, the registration unit 124 registers a correspondence between the acquired text and the specifying information for specifying an operable component. The registration unit 124 can acquire the correspondence between the name and the specifying information from the name/specifying-information correspondence storage unit 132. In addition, the registration unit 124 can provide the correspondence between the name and the specifying information to the information providing apparatus 300.

The registration unit 124 acquires a list of pairs of operable components and label components from the corresponding component list created by the classification unit 122. In addition, the registration unit 124 acquires the specifying information from the property information of the operable component. In addition, the registration unit 124 acquires the name (text information) from the property information of the label component. The registration unit 124 registers a pair of the specifying information and the name in a certain format.

(Storage Unit 130)

The storage unit 130 is implemented by, for example, a semiconductor memory element such as a RAM or a flash memory, or a storage device such as a hard disk or an optical disk. As illustrated in FIG. 4, the storage unit 130 includes a system screen information storage unit 131 and a name/specifying-information correspondence storage unit 132.

(System Screen Information Storage Unit 131)

The system screen information storage unit 131 stores information of the system screen. The system screen information storage unit 131 stores information of the system screen that is received by the acquisition unit 121.

(Name/Specifying-Information Correspondence Storage Unit 132)

The name/specifying-information correspondence storage unit 132 stores a name/specifying-information correspondence. The name/specifying-information correspondence is a correspondence between the name and the specifying information that is registered by the registration unit 124.

### 5. Flowchart of Information Acquisition Processing

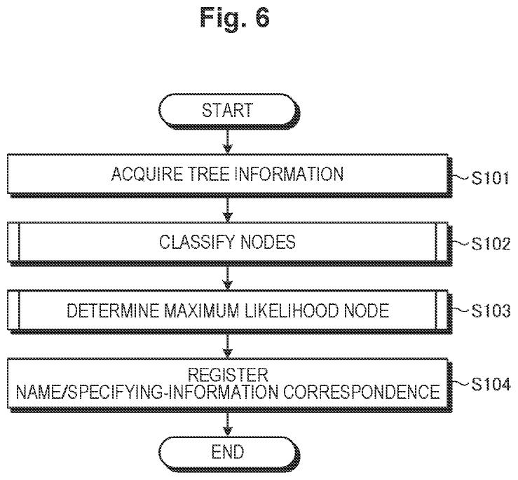

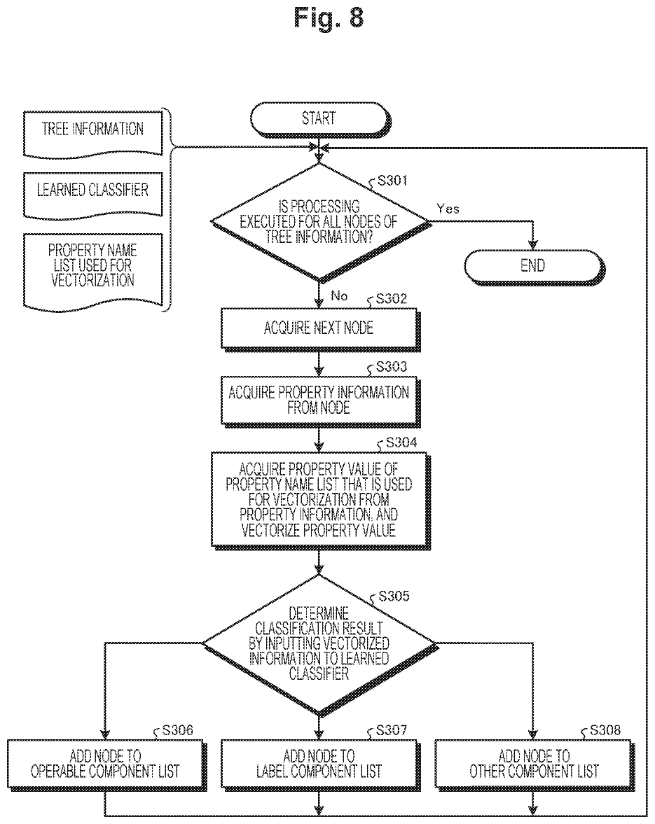

Next, a flowchart of an example of information acquisition processing will be described with reference to FIG. 6, FIG. 7, FIG. 8, FIG. 9, and FIG. 10. An example of information acquisition processing includes processing for automatically acquiring a correspondence between a name of a target of an automatic operation and specifying information for specifying the target of the automatic operation.

FIG. 6 is a flowchart illustrating an example of processing that is executed by the information acquisition apparatus 100 according to the embodiment and is for automatically acquiring a correspondence between a name of a target of an automatic operation and specifying information for specifying the target of the automatic operation.

As illustrated in FIG. 6, first, the acquisition unit 121 of the information acquisition apparatus 100 acquires tree information of a system screen (step S101).

Next, the classification unit 122 of the information acquisition apparatus 100 classifies a plurality of nodes included in the tree information into an operable component, a label component, and other components (step S102). The classification of the plurality of nodes included in the tree information into an operable component, a label component, and other components will be described in detail below with reference to FIG. 7 and FIG. 8.

Next, the determination unit 123 of the information acquisition apparatus 100 determines a maximum likelihood node as a node which is most likely to indicate the name of the operable component, from at least one node classified as a label component (step S103). The determination of the maximum likelihood node will be described in detail below with reference to FIG. 9 and FIG. 10.

Next, the registration unit 124 of the Information acquisition apparatus 100 registers the name/specifying-information correspondence based on a determination result of the maximum likelihood node (step S104).

For example, the registration unit 124 acquires a text corresponding to the maximum likelihood node from the tree information, as a name of the operable component. In addition, the registration unit 124 acquires specifying information for specifying the operable component from the tree information. In addition, the registration unit 124 associates the name with the specifying information, and stores a name/specifying-information correspondence in the name/specifying-information correspondence storage unit 132.

FIG. 7 is a flowchart illustrating an example of processing that is executed by the information acquisition apparatus 100 according to the embodiment and is for classifying a plurality of nodes into an operable component, a label component, and other components. The information acquisition apparatus 100 includes the tree information, the operable component control type list, and the label component determination condition. The information acquisition apparatus 100 executes processing to be described below by using the tree information, the operable component control type list, and the label component determination condition.

As illustrated in FIG. 7, first, the classification unit 122 of the information acquisition apparatus 100 determines whether the processing is executed for all the nodes of the tree information (step S201).

In a case where it is determined in step S201 that the processing is executed for all the nodes of the tree information (Yes in step S201), the processing procedure is ended.

In a case where it is determined in step S201 that the processing is not executed for all the nodes of the tree information (No in step S201), the classification unit 122 acquires the next node (step S202).

Next, the classification unit 122 acquires property information from the node (step S203).

Next, the classification unit 122 determines whether the control type of the property information exists in the operable component control type list (step S204).

In a case where it is determined in step S204 that the control type of the property information exists in the operable component control type list (Yes in step S204), the classification unit 122 adds the node to the operable component list (step S205). In addition, the classification unit 122 executes step S201 again.

In a case where it is determined in step S204 that the control type of the property information does not exist in the operable component control type list (No in step S204), the classification unit 122 determines whether the length of the text information of the property information satisfies the label component determination condition (step S206). For example, the classification unit 122 determines whether the length of the text information is equal to or longer than a minimum text length of the label determination condition and is shorter than a maximum text length of the label determination condition.

In a case where it is determined in step S206 that the length of the text information of the property information satisfies the label component determination condition (Yes in step S206), the classification unit 122 determines whether the size of the property information satisfies the label component determination condition (step S207). For example, the classification unit 122 determines whether the size of the property information is equal to or larger than a minimum size of the label determination condition and is smaller than a maximum size of the label determination condition.

In a case where it is determined in step S207 that the size of the property information satisfies the label component determination condition (Yes in step S207), the classification unit 122 adds the node to the label component list (step S208). In addition, the classification unit 122 executes step S201 again.

In a case where it is determined in step S206 that the length of the text information of the property information does not satisfy the label component determination condition (No in step S206), the classification unit 122 adds the node to the other component list (step S209). In addition, the classification unit 122 executes step S201 again.

In a case where it is determined in step S207 that the size of the property information does not satisfy the label component determination condition (No in step S207), the processing procedure proceeds to step S209. In addition, the classification unit 122 executes step S201 again.

FIG. 8 is a flowchart illustrating another example of processing that is executed by the information acquisition apparatus 100 according to the embodiment and is for classifying a plurality of nodes into an operable component, a label component, and other components. The information acquisition apparatus 100 includes tree information, a learned classifier, and a property name list that is used for vectorization. The information acquisition apparatus 100 executes processing to be described below by using the tree information, the learned classifier, and the property name list that is used for vectorization.

As illustrated in FIG. 8, first, the classification unit 122 of the information acquisition apparatus 100 determines whether the processing is executed for all the nodes of the tree information (step S301).

In a case where it is determined in step S301 that the processing is executed for all the nodes of the tree information (Yes in step S301), the processing procedure is ended.

In a case where it is determined in step S301 that the processing is not executed for all the nodes of the tree information (No in step S301), the classification unit 122 acquires the next node (step S302).

Next, the classification unit 122 acquires property information from the node (step S303).

Next, the classification unit 122 acquires a property value of the property name list that is used for vectorization from the property information, and vectorizes the property value (step S304). For example, the classification unit 122 selects a property value from the property information. In a case where the property value is not a numerical value, the classification unit 122 digitizes the property value by using a hash function or the like. In this way, the classification unit 122 converts the property information into an N-dimensional vector, and acquires vectorized information from the property information.

Next, the classification unit 122 determines a classification result by inputting the vectorized information to the learned classifier (step S305).

In step S305, in a case where the classification result is an operable component, the classification unit 122 adds the node to the variable operation component list (step S306). In addition, the classification unit 122 executes step S301 again.

In step S305, in a case where the classification result is a label component, the classification unit 122 adds the node to the label component list (step S307). In addition, the classification unit 122 executes step S301 again.

In step S305, in a case where the classification result is another component, the classification unit 122 adds the node to the other component list (step S308). In addition, the classification unit 122 executes step S301 again.

FIG. 9 is a flowchart illustrating an example of processing that is executed by the information acquisition apparatus 100 according to the embodiment and is for determining a maximum likelihood node as a node which is most likely to indicate a name of an operable component. The information acquisition apparatus 100 includes tree information, a variable operation component list, and a label component list. The information acquisition apparatus 100 executes processing to be described below by using the tree information, the variable operation component list, and the label component list.

In the example of FIG. 9, the information acquisition apparatus 100 narrows down the label components in order of the inter-node distance and the Euclidean distance.

As illustrated in FIG. 9, first, the determination unit 123 of the information acquisition apparatus 100 determines whether the processing is executed for all the operable components (step S401).

In a case where it is determined in step S401 that the processing is executed for all the operable components (Yes in step S401), the processing procedure is ended.

In a case where it is determined in step S401 that the processing is not executed for all the operable components (No in step S401), the determination unit 123 acquires a next operable component (step S402).

Next, the determination unit 123 calculates an inter-node distance between the operable component and all the label components, and extracts a label component having a minimum distance (step S403).

Next, the determination unit 123 determines whether a plurality of label components is extracted (step S404).

In a case where it is determined in step S404 that a plurality of label components is extracted (Yes in step S404), the determination unit 123 calculates a Euclidean distance between the operable component and all the extracted label components, and extracts a label component having a minimum distance (step S405).

Next, the determination unit 123 adds a pair of the operable component and the extracted label component to the corresponding component list (step S406). In addition, the determination unit 123 executes step S401 again.

In a case where it is determined in step S404 that a plurality of label components is not extracted (No in step S404), the processing procedure proceeds to step S406. In addition, the determination unit 123 executes step S401 again.

FIG. 10 is a flowchart illustrating another example of processing that is executed by the information acquisition apparatus 100 according to the embodiment and is for determining a maximum likelihood node as a node which is most likely to indicate a name of an operable component. The information acquisition apparatus 100 includes tree information, a variable operation component list, a label component list, a cost function, and parameters α and β. The information acquisition apparatus 100 executes processing to be described below by using the tree information, the variable operation component list, the label component list, the cost function, and the parameters α and β.

As illustrated in FIG. 10, first, the determination unit 123 of the information acquisition apparatus 100 determines whether the processing is executed for all the operable components (step S501).

In a case where it is determined in step S501 that the processing is executed for all the operable components (Yes in step S501), the processing procedure is ended.

In a case where it is determined in step S501 that the processing is not executed for all the operable components (No in step S501), the determination unit 123 acquires a next operable component (step S502).

Next, the determination unit 123 calculates an inter-node distance and a Euclidean distance between the operable component and all the label components (step 3503).

Next, the determination unit 123 derives a cost by inputting the calculated inter-node distance and the calculated Euclidean distance to the cost function obtained by applying the parameters α and β (step S504).

Next, the determination unit 123 extracts a label component having a minimum cost (step 3505).

Next, the determination unit 123 adds a pair of the operable component and the extracted label component to the corresponding component list (step S506). In addition, the determination unit 123 executes step 3501 again.

### 6. Other Embodiments

The information acquisition apparatus 100 according to the above-described embodiment may be implemented in various different forms other than the above-described embodiment. In addition, in the following, another embodiment of the information acquisition apparatus 100 will be described.

[6-1. Acquisition of Variable Operation Component]

The variable operation component may be provided in advance. For example, the information acquisition apparatus 100 may acquire a variable operation component from the information providing apparatus 300. In addition, the information acquisition apparatus 100 may search for a name of the provided variable operation component.

For example, it is assumed that a specifying information list for variable operation components is given in advance. In this case, the information acquisition apparatus 100 may create an operable component list from the specifying information list that is given in advance. In addition, the information acquisition apparatus 100 may use the operable component list for processing for determining a maximum likelihood node.

[6-2. Interaction with User]

In a stage where the label component(s) is/are determined, the information acquisition apparatus 100 may present the label component to the user by a certain method. In addition, the information acquisition apparatus 100 may receive a user input such as OK or NG, and interactively determine a label component. In a case where a plurality of label component candidates exists, the user may select a label component from among the plurality of label component candidates.

[6-3. Situation where Corresponding Label Component does not Exist]

The corresponding label component may not necessarily be found. The information acquisition apparatus 100 may set the Euclidean distance and the inter-node distance to a maximum distance. The label component having the Euclidean distance and the inter-node distance equal to or longer than the maximum distance may be excluded from the determination target. In the embodiment, in a case where the corresponding label component is not found, the information acquisition apparatus 100 may output a result indicating “corresponding label component does not exist”.

### 7. Effects

As described above, the information acquisition apparatus 100 according to the embodiment includes an acquisition unit 121, a classification unit 122, a determination unit 123, and a registration unit 124.

In the information acquisition apparatus 100 according to the embodiment, the acquisition unit 121 acquires tree information representing information of a system screen by a plurality of nodes having a tree structure. Further, in the information acquisition apparatus 100 according to the embodiment, the classification unit 122 classifies the plurality of nodes having a tree structure into an operable component and a label component based on the tree information. Further, in the information acquisition apparatus 100 according to the embodiment, the determination unit 123 determines whether the label component indicates the name of the operable component based on a distance between the operable component and the label component. Further, in the information acquisition apparatus 100 according to the embodiment, the registration unit 124 registers a correspondence between a text corresponding to the label component and specifying information for specifying the operable component in a case where the determination unit 123 determines that the label component indicates a name of the operable component.

Further, in the information acquisition apparatus 100 according to the embodiment, the determination unit 123 determines whether the label component indicates a name of the operable component based on a distance between a position at which the operable component is displayed and a position at which the label component is displayed.

Further, in the information acquisition apparatus 100 according to the embodiment, the determination unit 123 determines whether the label component indicates a name of the operable component based on a distance between a node corresponding to the operable component and a node corresponding to the label component.

Further, in the information acquisition apparatus 100 according to the embodiment, the determination unit 123 determines whether the label component indicates a name of the operable component based on a distance between a node corresponding to the operable component and a node corresponding to the label component.

Further, in the information acquisition apparatus 100 according to the embodiment, the classification unit 122 acquires property information of the plurality of nodes from the tree information, and classifies the plurality of nodes into an operable component and a label component based on the acquired property information.

Further, in the information acquisition apparatus 100 according to the embodiment, the classification unit 122 classifies the plurality of nodes into an operable component and a label component by converting the acquired property information into a vector and inputting the property information converted into the vector to a classifier that is learned to classify a vector corresponding to property information of a UI component into an operable component and a label component.

Further, in the information acquisition apparatus 100 according to the embodiment, the registration unit 124 acquires property information of a node corresponding to the label component from the tree information, acquires a text corresponding to the label component from the acquired property information, and registers a correspondence between the acquired text and specifying information for specifying the operable component.

By the processing described above, the information acquisition apparatus 100 can easily acquire a correspondence between a name of a component as a target of an automatic operation and information for specifying the component.

### 8. Others

Further, in the processing described in the embodiment, a part of the processing described as being automatically performed can also be manually performed. Alternatively, all or a part of the processing described as being manually performed can be automatically performed by a known method. In addition, the processing procedures, the specific names, and the information including various data and parameters described in the specification and the drawings can be freely changed unless otherwise specified. For example, various types of information illustrated in the drawings are not limited to the illustrated information.

In addition, each component of each apparatus illustrated in the drawings is functionally conceptual, and is not necessarily physically configured as illustrated in the drawings. That is, a specific form of distribution and integration of individual apparatuses is not limited to the illustrated form, and all or a part of the configuration can be functionally or physically distributed and integrated in any unit according to various loads, usage conditions, and the like.

For example, a part of or the entire storage unit 130 illustrated in FIG. 4 may be held in a storage server or the like instead of being held by the information acquisition apparatus 100. In this case, the information acquisition apparatus 100 acquires various types of information such as information of the system screen by accessing the storage server.

### 9. Hardware Configuration

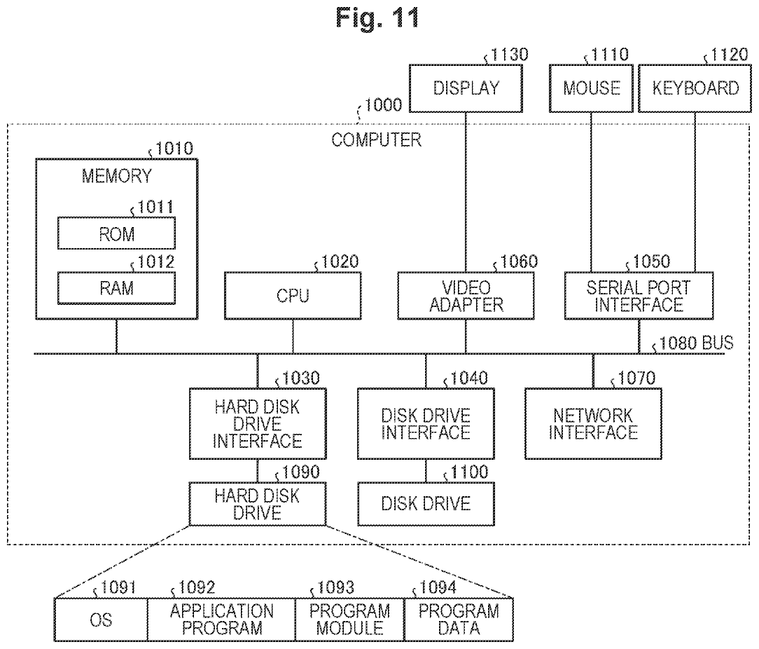

FIG. 11 is a diagram illustrating an example of a hardware configuration. The information acquisition apparatus 100 according to the above-described embodiment is implemented by, for example, a computer 1000 having a configuration as illustrated in FIG. 11.

FIG. 11 illustrates an example of a computer that implements the information acquisition apparatus 100 by executing a program. A computer 1000 includes, for example, a memory 1010 and a CPU 1020. In addition, the computer 1000 further includes a hard disk drive interface 1030, a disk drive interface 1040, a serial port interface 1050, a video adapter 1060, and a network interface 1070. These units are connected to each other by a bus 1080.

The memory 1010 includes a read only memory (ROM) 1011 and a RAM 1012. The ROM 1011 stores, for example, a boot program such as a basic input output system (BIOS). The hard disk drive interface 1030 is connected to a hard disk drive 1090. The disk drive interface 1040 is connected to a disk drive 1100. For example, a removable storage medium such as a magnetic disk or an optical disc is inserted into the disk drive 1100. The serial port interface 1050 is connected to, for example, a mouse 1110 and a keyboard 1120. The video adapter 1060 is connected to, for example, a display 1130.

The hard disk drive 1090 stores, for example, an OS 1091, an application program 1092, a program module 1093, and program data 1094. That is, the program that defines each type of processing performed by the information acquisition apparatus 100 is implemented as the program module 1093 in which a code which can be executed by the computer 1000 is described. The program module 1093 is stored in, for example, the hard disk drive 1090. For example, the program module 1093 for executing processing similar to the functional configuration of the information acquisition apparatus 100 is stored in the hard disk drive 1090. Note that the hard disk drive 1090 may be replaced with a solid state drive (SSD).

Further, setting data used in the processing of the above-described embodiment is stored, for example, in the memory 1010 or the hard disk drive 1090, as the program data 1094. In addition, the CPU 1020 reads the program module 1093 and the program data 1094 stored in the memory 1010 and the hard disk drive 1090 into the RAM 1012 as necessary, and executes the program module 1093.

Note that the program module 1093 and the program data 1094 are not limited to being stored in the hard disk drive 1090, and may be stored in, for example, a removable storage medium and read by the CPU 1020 via the disk drive 1100 or the like. Alternatively, the program module 1093 and the program data 1094 may be stored in another computer connected via a network (for example, LAN, WAN, or the like). In addition, the program module 1093 and the program data 1094 may be read by the CPU 1020 from the other computer via the network interface 1070.

Although certain embodiments of the present application have been described above in detail with reference to the drawings, the embodiments are merely examples, and the present invention is not limited to specific examples. The features described in the present specification can be implemented in other forms with various modifications and improvements on the basis of knowledge of those skilled in the art, including the aspects described in the section “Description of Embodiments”.

Further, the “unit” described above can be read as a module, a section, a means, a circuit, or the like. For example, the registration unit can be replaced with a registration module or a registration circuit.

### REFERENCE SIGNS LIST

1 Information acquisition system
100 Information acquisition apparatus
110 Communication unit
120 Control unit
121 Acquisition unit
122 Classification unit
123 Determination unit
124 Registration unit
130 Storage unit
131 System screen information storage unit
132 Name/specifying-information correspondence storage unit
200 Network
300 Information providing apparatus

1. An information acquisition apparatus comprising:
a memory; and
a processor coupled to the memory and configured to perform operations comprising:
acquiring tree information representing information of a system screen by a plurality of nodes having a tree structure;
classifying the plurality of nodes having a tree structure into an operable component and a label component based on the tree information;
determining whether the label component indicates a name of the operable component based on a distance between the operable component and the label component; and
in response to determining that the label component indicates a name of the operable component, a registering a correspondence between a text corresponding to the label component and specifying information for specifying the operable component.

2. The information acquisition apparatus of claim 1, wherein determining whether the label component indicates a name of the operable component includes determining whether the label component indicates a name of the operable component based on a distance between a position at which the operable component is displayed and a position at which the label component is displayed.

3. The information acquisition apparatus of claim 1, wherein determining whether the label component indicates a name of the operable component includes determining whether the label component indicates a name of the operable component based on a distance between a node corresponding to the operable component and a node corresponding to the label component.

4. The information acquisition apparatus of claim 1, wherein classifying the plurality of nodes based on the tree information includes:
acquiring property information of the plurality of nodes from the tree information; and
classifying the plurality of nodes into an operable component and a label component based on the acquired property information.

5. The information acquisition apparatus according to claim 4, wherein classifying the plurality of nodes based on the acquired property information includes:
converting the acquired property information into a vector; and
classifying the plurality of nodes into an operable component and a label component by inputting the property information converted into the vector to a classifier, wherein the classifier is learned to classify a vector corresponding to property information of a UI component into an operable component and a label component.

6. The information acquisition apparatus of claim 1, wherein registering a correspondence between a text corresponding to the label component and the specifying information includes:
acquiring property information of a node corresponding to the label component from the tree information;
acquiring a text corresponding to the label component from the acquired property information; and
registering a correspondence between the acquired text and the specifying information.

7. An information acquisition method performed by a computer, the method comprising:
acquiring tree information representing information of a system screen by a plurality of nodes having a tree structure;
classifying the plurality of nodes having a tree structure into an operable component and a label component based on the tree information;
determining whether the label component indicates a name of the operable component based on a distance between the operable component and the label component; and
in response to determining that the label component indicates a name of the operable component, registering a correspondence between a text corresponding to the label component and specifying information for specifying the operable component.

8. A non-transitory computer readable storage medium having a information acquisition program stored thereon that, when executed by a processor, causes the processor to perform operations comprising:
acquiring tree information representing information of a system screen by a plurality of nodes having a tree structure;
classifying the plurality of nodes having a tree structure into an operable component and a label component based on the tree information;
determining whether the label component indicates a name of the operable component based on a distance between the operable component and the label component; and
in response to determining that the label component indicates a name of the operable component, registering a correspondence between a text corresponding to the label component and specifying information for specifying the operable component.
